(19) United States
(12) Patent Application Publication
(10) Pub. No.: US 2014/0240968 A1
(43) Pub. Date: Aug. 28, 2014

(54) SOLAR POWERED LED PORTABLE LIGHT TOWER

(71) Applicant: Cubed, LLC, Los Angeles, CA (US)

(72) Inventor: Jacob Embree Brown, Los Angeles, CA (US)

(73) Assignee: Cubed, LLC, Los Angeles, CA (US)

(21) Appl. No.: 14/189,800

(22) Filed: Feb. 25, 2014

Related U.S. Application Data
(60) Provisional application No. 61/769,700, filed on Feb. 26, 2013.

(51) Int. Cl. F21L 4/08

(52) U.S. Cl. CPC F21L 4/08
USPC 362/183

(57) ABSTRACT

A solar powered LED portable light tower. A solar powered LED portable light tower may comprise: one or more photovoltaic modules, an adjustable masthead, one or more lamps, one or more batteries, an inverter, a controller, and a base. The lamps may be light emitting diodes. The controller may be configured to turn on and off and dim said one or more lamps, and preferably comprises a motion sensor. The portable light tower may also comprise a concrete ballast, fork lift option, and/or a trailer option.

### CROSS-REFERENCE TO RELATED APPLICATIONS

This application takes priority from U.S. Provisional Patent Application No. 61/769,700, filed on Feb. 26, 2013, titled “Solar Powered LED Portable Light Tower”, by inventors Jacob Embree Brown, the contents of which are expressly incorporated herein by this reference as though set forth in their entirety, and to which priority is claimed.

### FIELD OF INVENTION

The present disclosure generally relates to portable light towers. More particularly, the invention generally relates to a solar powered portable light tower that is wind resistant, rugged, stable, quiet, and self-sustaining.

### BACKGROUND

Many events generally require the use of portable light towers to provide illumination to those events. A light tower is generally a piece of mobile equipment that has one or more high-intensity electric lamps and a mast. The lights are usually attached to the mast, which is usually attached to a trailer with a fuel generator set to power the lamps.

Current portable light towers, however, are usually diesel powered and have significant limitations. For example, current portable light towers are generally unsafe to use at locations with high winds. Additionally, the diesel generator: (1) must be maintained; (2) usually consists of many moving parts; (3) generally require 1.3 to 2 gallons of diesel fuel per hour; (4) generally require 500 hours of scheduled maintenance; (5) are usually extremely noisy; and (6) usually emit 34 tons of CO2/yr. emissions.

Furthermore, regarding the high intensity lamps, the lamps are: (1) usually not very bright (each portable light tower only includes 3 or 4 lamps or 600 to 1000 watt lamps); (2) have a short life span of 7-10 years; (3) are usually non-dimmable; (4) lack motion sensors; and (5) have no lighting controls

Thus, what is needed is a portable light tower that overcomes these limitations. Preferably, the portable light tower will be safe to use around high winds and is able to utilize various functions such as dimming, lighting controls, and motion sensors. Additionally, the portable light tower preferably comprises components that are easy to be maintained.

### SUMMARY OF THE INVENTION

To minimize the limitations in the prior art, and to minimize other limitations that will become apparent upon reading and understanding the present specification, the present invention is a portable light tower that is battery operated, stable, and flexible.

One embodiment of the invention is a portable light tower comprising: one or more photovoltaic modules; an adjustable masthead; one or more lamps; one or more batteries; an inverter; a controller; and a base. The one or more lamps are preferably comprised of a plurality of light emitting diodes. The controller is preferably configured to turn on and off and dim the lamps. The tower may further comprise a motion sensor. The one or more batteries may be in a vented battery box. The base may be comprised of a concrete ballast and a rubber mat insulator. The portable light tower may further comprise a trailer option. The portable light tower may further comprise a fork lift option.

Another embodiment is a portable light tower comprising: one or more photovoltaic modules; an adjustable masthead; one or more lamps; one or more batteries; an inverter; a controller; and a base; wherein the one or more lamps may comprise a plurality of light emitting diodes. The controller may be configured to turn on and off and dim the one or more lamps. The portable light tower may further comprise a motion sensor. The one or more batteries may be in a vented battery box; wherein the base may be comprised of a concrete ballast and a rubber mat insulator. The portable light tower may further comprise a trailer option. The portable light tower may further comprise a fork lift option.

Another embodiment may be a portable light tower comprising: one or more photovoltaic modules; an adjustable masthead; one or more lamps; one or more batteries; an inverter; a controller; and a base; wherein the one or more photovoltaic modules may be configured to convert solar energy to an electrical energy; wherein the inverter may convert electrical energy to direct current; wherein the direct current may be stored into the one or more batteries; wherein the one or more lamps may be attached to the adjustable masthead and comprises a plurality of light emitting diodes; wherein the adjustable masthead may be attached to the base and is configured to vertically adjust the height of the one or more lamps; wherein the direct current may be configured to light the plurality of light emitting diodes; and wherein controller may be configured to turn on and off and dim the plurality of light emitting diodes of the one or more lamps; The portable light tower may further comprise a motion sensor; wherein the motion sensor may be configured to activate the controller to light up the one or more lamps when the motion sensor is triggered. The one or more batteries may be stored in a vented battery box. The base may be comprised of a concrete ballast and a rubber mat insulator. The portable light tower may further comprise a trailer option; wherein the trailer option may comprise a drawbar connected to the base of the portable light tower; wherein the trailer option may allow the portable light tower to be mounted on a vehicle by connecting the drawbar to a connecting rod of the vehicle. The portable light tower may further comprise a forklift option; wherein the forklift option may comprise one or more rails; and wherein the one or more rails may be configured to engage with a fork of a forklift vehicle for lifting the portable light tower.

Another embodiment may be a portable light tower comprising: one or more photovoltaic modules; an adjustable masthead; one or more lamps; one or more batteries; an inverter; a controller; a base; a motion sensor; a trailer option; and a forklift option; wherein the one or more photovoltaic modules are configured to convert solar energy to an electrical energy; wherein the inverter converts electrical energy to direct current; wherein the direct current is stored into the one or more batteries; wherein the one or more lamps are attached to the adjustable masthead and comprises a plurality of light emitting diodes; wherein the adjustable masthead is attached to the base and is configured to vertically adjust the height of the one or more lamps; wherein the direct current is configured to light the plurality of light emitting diodes; wherein controller is configured to turn on and off and dim the plurality of light emitting diodes of the one or more lamps; wherein the motion sensor is configured to activate the controller to light up the one or more lamps when the motion sensor is triggered; wherein the one or more batteries are stored in a vented battery box; wherein the base is comprised of a concrete ballast and a rubber mat insulator; wherein the trailer option comprises a drawbar connected to the base of the portable light tower; wherein the trailer option allows the portable light tower to be mounted on a vehicle by connecting the drawbar to a connecting rod of the vehicle; wherein the forklift option comprises one or more rails; and wherein the one or more rails are configured to engage with a fork of a forklift vehicle for lifting the portable light tower.

It is an object to overcome the limitations of the prior art.

It is an object to provide a portable, stable, rugged, no fuel required, long lasting, bright, dimmable, easy to use, essentially maintenance free, quite, pollution free, solar powered, self-sustaining light tower.

It is an object to provide a portable light tower with a concrete ballast option.

It is an object to provide a portable light tower with a trailer option.

It is an object to provide a portable light tower with a fork lift option.

Additional embodiments of the invention will be understood from the detailed description of the invention.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a side view of one embodiment of the portable light tower.

FIG. 2 is an illustration of a front view of one embodiment of the portable light tower.

FIG. 3 is an illustration of an exploded view of one embodiment of the portable light tower.

FIG. 4 is an illustration of a side view of another embodiment of the portable light tower that is moved by a forklift and is in travel position.

FIG. 5 is an illustration of a side view of another embodiment of the portable light tower that is a portable trailer.

FIG. 6 is an illustration of a side view of another embodiment of the portable light tower that is a portable trailer and is in travel position.

FIG. 7 is an illustration of a top view of another embodiment of the portable light tower that is a portable trailer.

FIG. 8 is an illustration of one embodiment of the control box of the light tower.

FIG. 9 is an illustration of a top perspective view of one embodiment of the portable light tower.

FIG. 10 is an illustration of a side perspective view of one embodiment of the portable light tower.

### DETAILED DESCRIPTION OF ILLUSTRATIVE EMBODIMENTS

In the following detailed description of various embodiments, numerous specific details are set forth in order to provide a thorough understanding of various aspects of one or more embodiments. However, one or more embodiments may be practiced without some or all of these specific details. In other instances, well-known methods, procedures, and/or components have not been described in detail so as not to unnecessarily obscure aspects of the embodiments.

While multiple embodiments are disclosed, still other embodiments of the present disclosure will become apparent to those skilled in the art from the following detailed description, which shows and describes illustrative embodiments. As will be realized, the embodiments are capable of modifications in various obvious aspects, all without departing from the spirit and scope of the present disclosure. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

One embodiment of the light emitting diode (LED) photovoltaic portable light tower may have the following features: portable; may be moved by a fork truck; stable so as to withstand 95 MPH winds; rugged with no moving parts; no fuel required; 19-20 years between lamp changes; lumens equivalent to (3) 600 watt lamps; 10 years between battery changes; over 20 total life span; essentially maintenance free; noiseless; no emissions; advanced lighting controls; self-sustaining; and motion sensor capability.

Although LEDs are preferred, any type of lamp, bulb, or light source may be used, including, but not limited to, LED, fluorescent, induction, incandescent, high-output fluorescent, compact fluorescent, high-output fluorescent/high-intensity discharge hybrids, high-pressure sodium (HPS), combination metal halide (MH) and HPS, metal halide, and/or high intensity discharge, without deviating from the scope of the invention.

The portable light tower is configured to have at least the following life span: modules—25 years; structure—25 years; batteries 9-12 years; inverter 7-10 years; LED lamps 19 years (50,000 hours). After 10 years the batteries and inverter may be changed out and the system will last for another 10 years, which may cost approximately $10,000. The portable light tower may initially cost approximately $50,000. The maintenance is approximately $300/year with no emissions and no fuel cost. This is a total cost of $66,000 over 20 years. Currently available diesel light towers, inclusive of fuel costs, would cost well over $300,000. This is a massive cost savings.

The LED lighting is a significant improvement because it may provide superior light quality in work areas, including, light across the visible spectrum, which enables the workers to see all colors and details more easily, and the high lumen levels provide a large work area footprint. The tower preferably has a variable height, which may derive from a telescoping feature. The portable light tower preferably has a locked control box that has a security mode for all night surveillance. May be moved via fork lift of trailer. May also provide external power outlets to power other devices. May be configured to withstand marine conditions. Is low maintenance, requires no fuel (only sunlight), no emissions, and no noise. May include motion sensors and sealed maintenance free batteries.

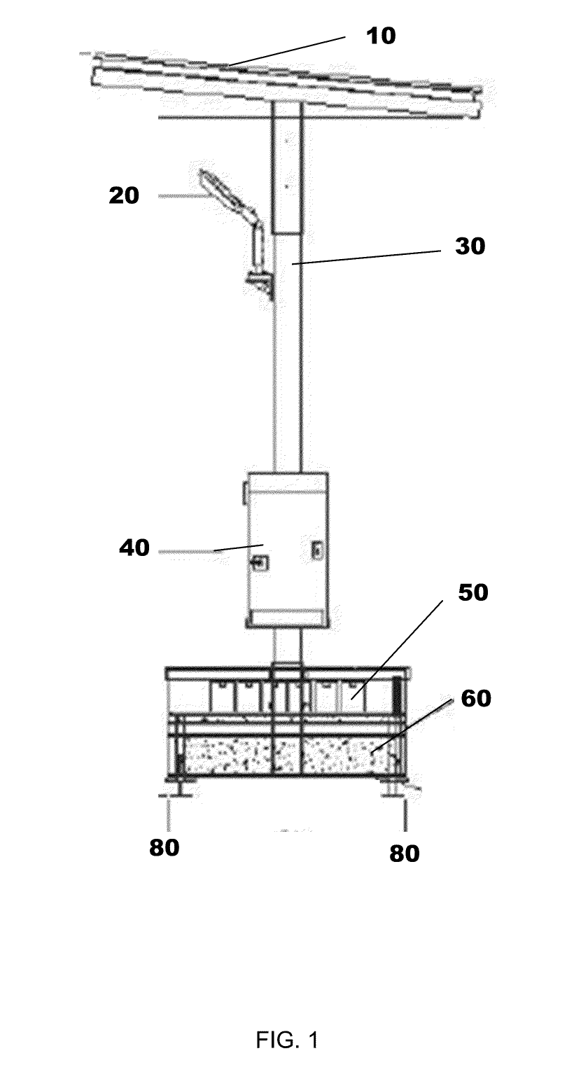

FIG. 1 is an illustration of a side view of one embodiment of the portable light tower. As shown in FIG. 1, one embodiment of the portable light tower may comprise a photovoltaic panel 10, LED array 20, telescoping pole 30, control box 40, batteries 50, base 60, which may be concrete, legs 80. The lights are preferably powered by the batteries, which are recharged through an inverter and the photovoltaic panel 10. In this embodiment, the portable light tower generally has three 600 LED lamps, which are generally rated for 95 mph winds.

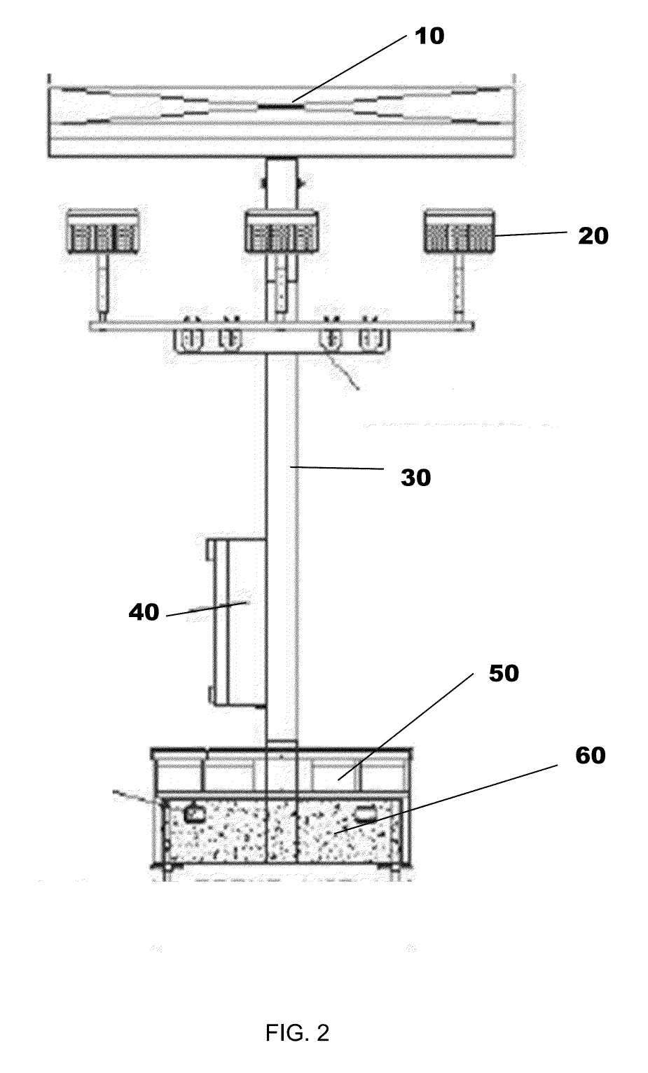

FIG. 2 is an illustration of a front view of one embodiment of the portable light tower. As shown in FIG. 2 the portable light tower may comprise a photovoltaic panel 10, LED array 20, telescoping pole 30, control box 40, batteries 50, base 60, which may be concrete. The lights are preferably powered by the batteries, which are recharged through an inverter and the photovoltaic panel 10. In this embodiment, like FIG. 1, the portable light tower generally has three 600 LED lamps, which are generally rated for 95 mph winds.

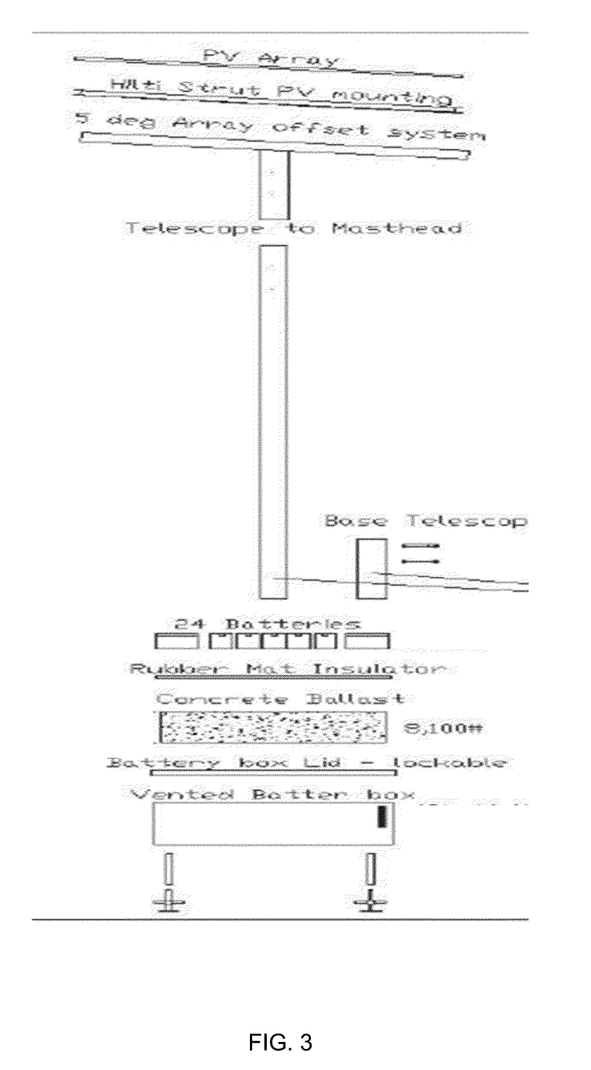

FIG. 3 is an illustration of an exploded view of one embodiment of the portable light tower. In this embodiment, like FIGS. 1 and 2, the portable light tower generally has three 600 LED lamps, which are generally rated for 95 mph winds.

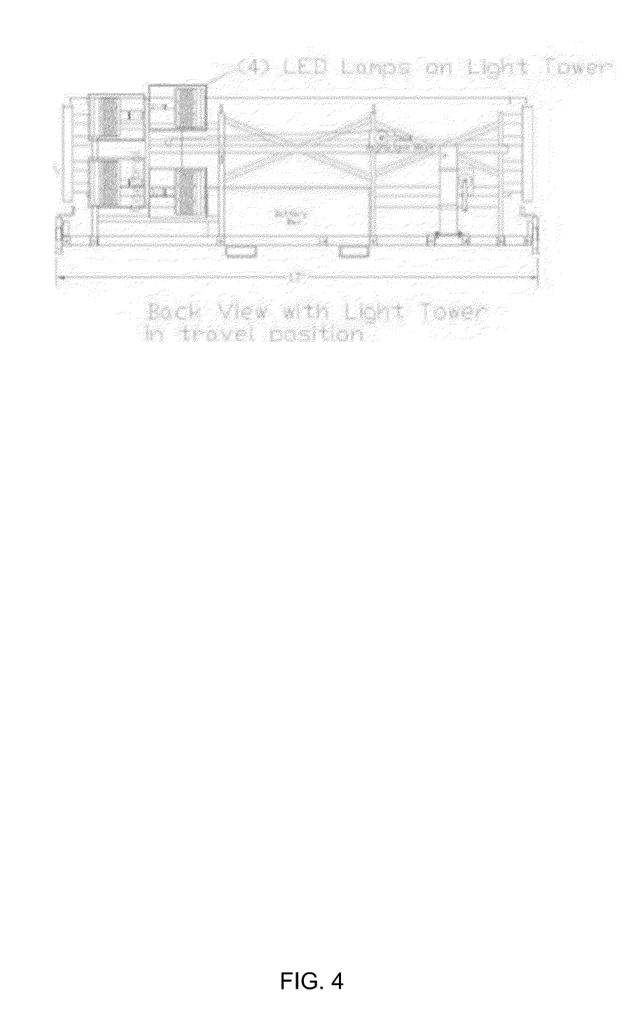

FIG. 4 is an illustration of a side view of another embodiment of the portable light tower that is moved by a forklift and is in travel position. In this embodiment, the portable light tower generally has four 600 watt LED lamps located in the low upright position, which are generally rated for 125 mph winds. The lamps located at the tallest position are generally rated for 65 mph winds (horizontal to vertical tilting and telescopic mast from approximately 15 feet to 34½ ft.).

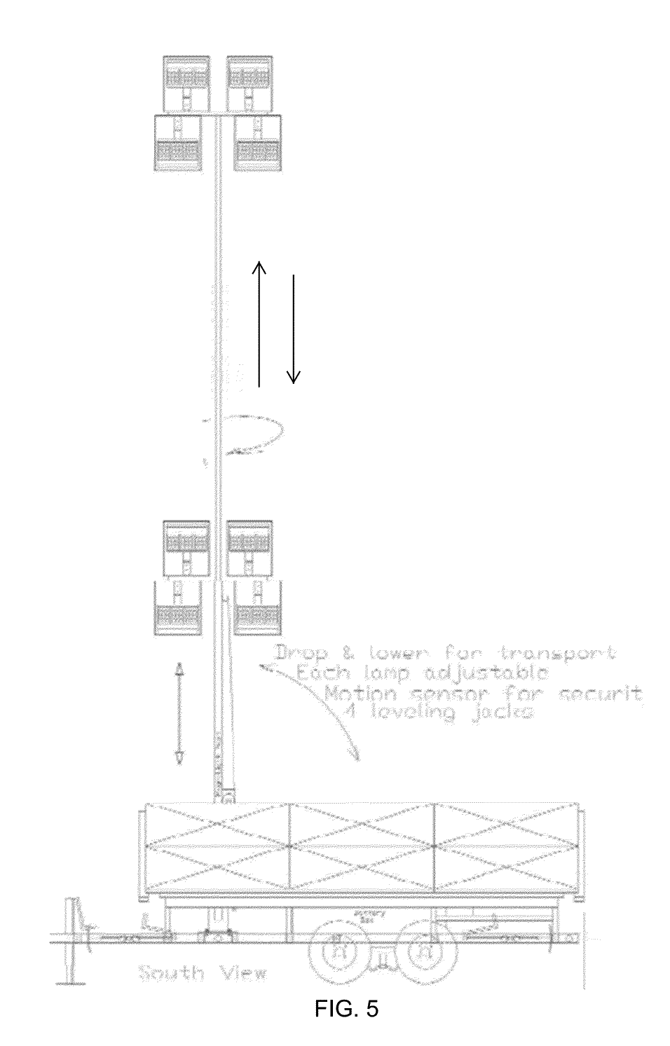

FIG. 5 is an illustration of a side view of another embodiment of the portable light tower that is a portable trailer. In this embodiment, the portable light tower generally has four 600 watt LED lamps located in the low upright position, which are generally rated for 125 mph winds. The lamps located at the tallest position are generally rated for 65 mph winds (horizontal to vertical tilting and telescopic mast from approximately 15 feet to 34½ ft.).

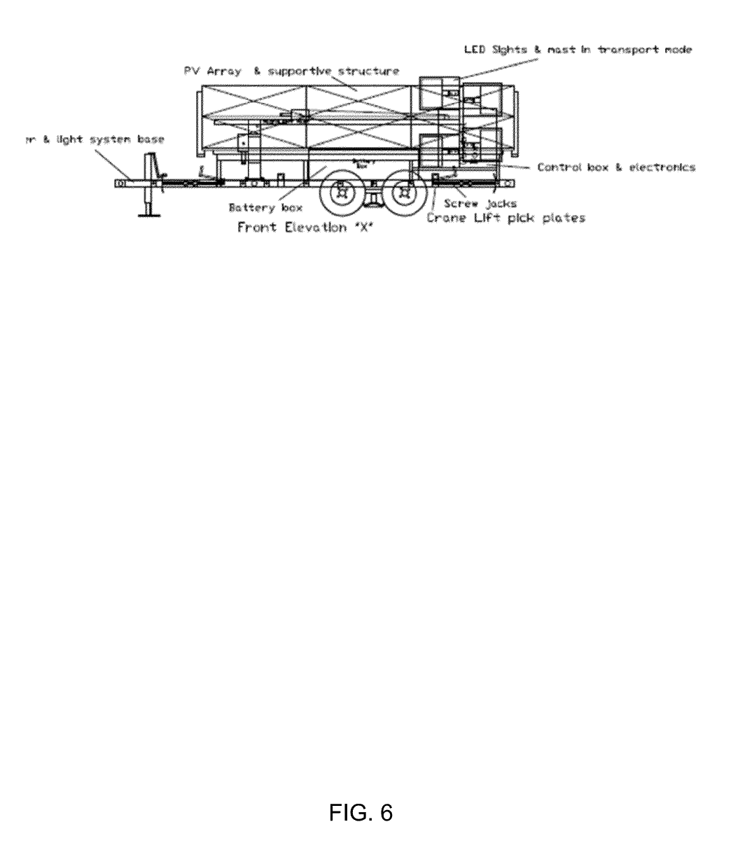

FIG. 6 is an illustration of a side view of another embodiment of the portable light tower that is a portable trailer and is in travel position. In this embodiment, the portable light tower generally has four 600 watt LED lamps located in the low upright position, which are generally rated for 125 mph winds. The lamps located at the tallest position are generally rated for 65 mph winds (horizontal to vertical tilting and telescopic mast from approximately 15 feet to 34½ ft.).

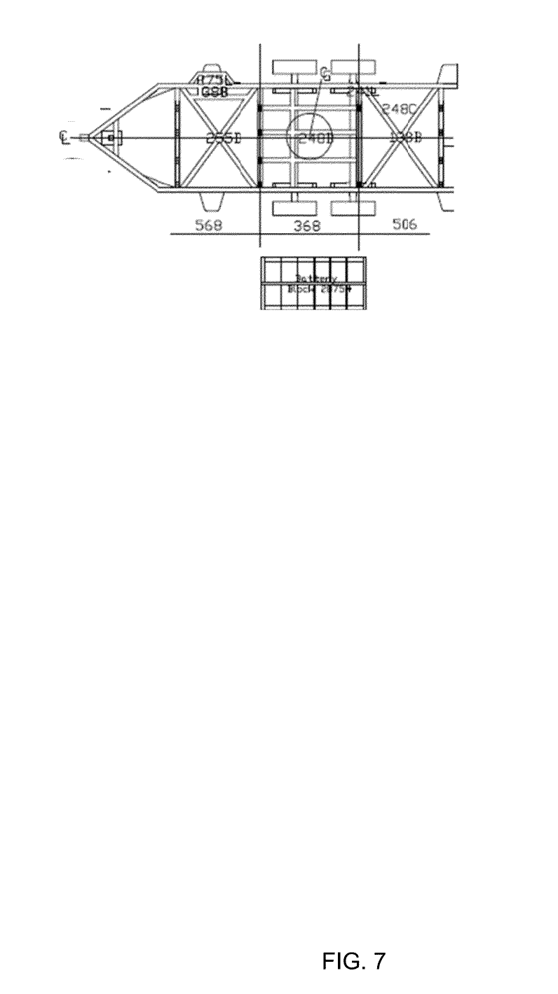

FIG. 7 is an illustration of a top view of another embodiment of the portable light tower that is a portable trailer. In this embodiment, the portable light tower generally has four 600 watt LED lamps located in the low upright position, which are generally rated for 125 mph winds. The lamps located at the tallest position are generally rated for 65 mph winds (horizontal to vertical tilting and telescopic mast from approximately 15 feet to 34½ ft.).

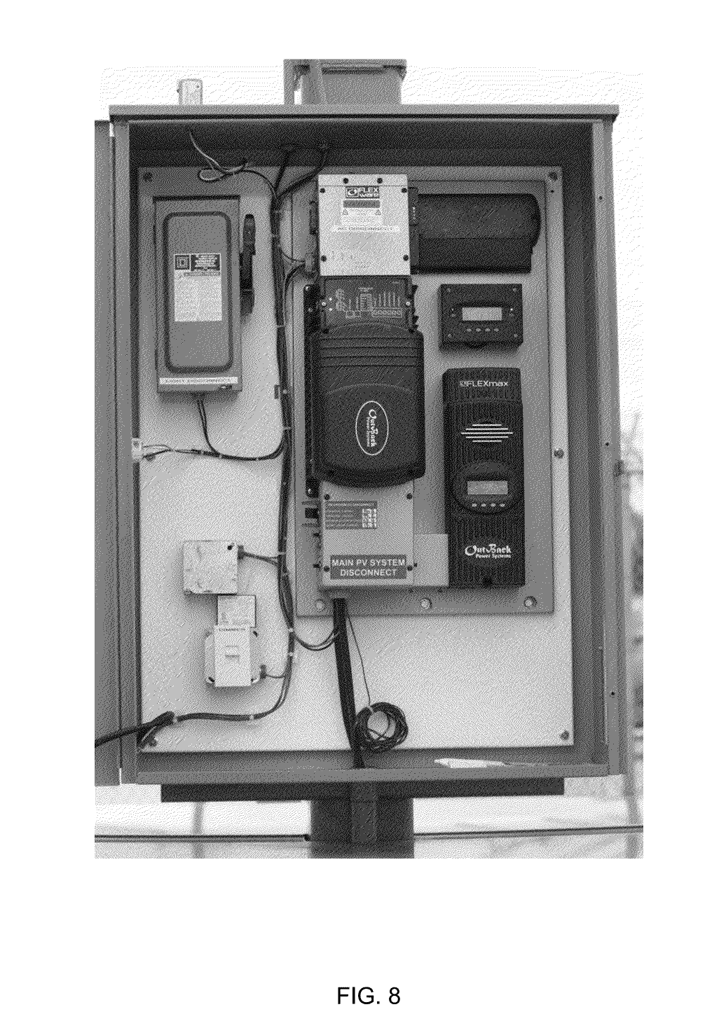

FIG. 8 is an illustration of one embodiment of the control box of the light tower.

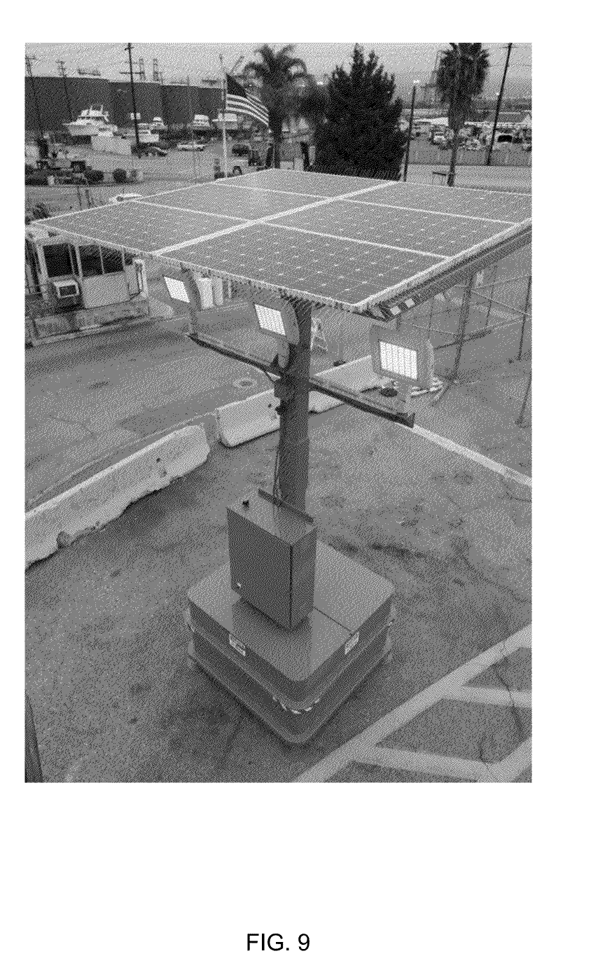

FIG. 9 is an illustration of a top perspective view of one embodiment of the portable light tower. In this embodiment, like FIGS. 1-3, the portable light tower generally has three 600 LED lamps, which are generally rated for 95 mph winds.

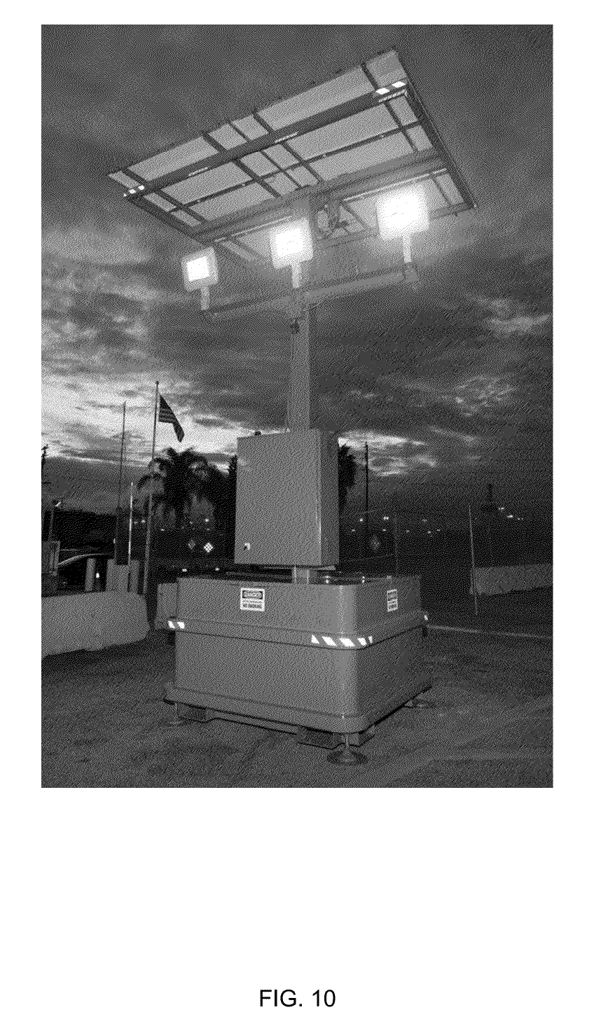

FIG. 10 is an illustration of a side perspective view of one embodiment of the portable light tower. In this embodiment, like FIGS. 1-3 and 9, the portable light tower generally has three 600 LED lamps, which are generally rated for 95 mph winds.

In a preferred embodiment, the portable light tower may have the following attributes:

| | |
|---|---|
| Operation mode | approximately 100% to 10% |
| | dimmable |
| Security mode: motion sensors | approximately 100% to 10% |
| | dimmable |
| The unit generally has an AC output | approximately 15 amp/120 V |
| The unit generally has an AC input | for charging the batteries remotely |
| The unit may have a photo-sensor to | The unit may also have a bypass |
| turn the unit off in daylight | switch to allow for the lights |
| | to be used in daylight |

Each LED lamp is generally 172 watts. Thus, 3 lamps may have a total wattage of 516 watts, and 4 lamps may have a total wattage of 688 watts.

Conventional metal halide lights filaments are generally fragile and may be prone to damage during transportation. On the other hand, the LEDs disclosed herein are generally rugged and usually will not break.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent to the public, regardless of whether it is or is not recited in the claims.

What is claimed is:

1. A portable light tower comprising:
one or more photovoltaic modules;
an adjustable masthead;
one or more lamps;
one or more batteries;
an inverter;
a controller; and
a base;

2. The portable light tower of claim 1, wherein said one or more lamps are comprised of a plurality of light emitting diodes.

3. The portable light tower of claim 1, wherein controller is configured to turn on and off and dim said one or more lamps.

4. The portable light tower of claim 1, further comprising a motion sensor.

5. The portable light tower of claim 1, wherein said one or more batteries are in a vented battery box; wherein said base is comprised of a concrete ballast and a rubber mat insulator.

6. The portable light tower of claim 1, further comprising a trailer option.

7. The portable light tower of claim 1, further comprising a fork lift option.

8. A portable light tower comprising:
one or more photovoltaic modules;
an adjustable masthead;
one or more lamps;
one or more batteries;
an inverter;
a controller; and
a base;
wherein said one or more photovoltaic modules are configured to convert solar energy to an electrical energy;
wherein said inverter converts electrical energy to direct current;
wherein said direct current is stored into said one or more batteries;
wherein said one or more lamps are attached to said adjustable masthead and comprises a plurality of light emitting diodes;
wherein said adjustable masthead is attached to said base and is configured to vertically adjust the height of said one or more lamps;
wherein said direct current is configured to light said plurality of light emitting diodes; and
wherein controller is configured to turn on and off and dim said plurality of light emitting diodes of said one or more lamps;

9. The portable light tower of claim 8, further comprising a motion sensor;
wherein said motion sensor is configured to activate said controller to light up said one or more lamps when said motion sensor is triggered.

10. The portable light tower of claim 8, wherein said one or more batteries are stored in a vented battery box.

11. The portable light tower of claim 8, wherein said base is comprised of a concrete ballast and a rubber mat insulator.

12. The portable light tower of claim 8, further comprising a trailer option;
wherein said trailer option comprises a drawbar connected to said base of said portable light tower;
wherein said trailer option allows said portable light tower to be mounted on a vehicle by connecting said drawbar to a connecting rod of said vehicle.

13. The portable light tower of claim 8, further comprising a forklift option;
wherein said forklift option comprises one or more rails; and
wherein said one or more rails are configured to engage with a fork of a forklift vehicle for lifting said portable light tower.

14. A portable light tower comprising:
one or more photovoltaic modules;
an adjustable masthead;
one or more lamps;
one or more batteries;
an inverter;
a controller;
a base;
a motion sensor;
a trailer option; and
a forklift option;
wherein said one or more photovoltaic modules are configured to convert solar energy to an electrical energy;
wherein said inverter converts electrical energy to direct current;
wherein said direct current is stored into said one or more batteries;
wherein said one or more lamps are attached to said adjustable masthead and comprises a plurality of light emitting diodes;
wherein said adjustable masthead is attached to said base and is configured to vertically adjust the height of said one or more lamps;
wherein said direct current is configured to light said plurality of light emitting diodes; and
wherein controller is configured to turn on and off and dim said plurality of light emitting diodes of said one or more lamps;
wherein said motion sensor is configured to activate said controller to light up said one or more lamps when said motion sensor is triggered;
wherein said one or more batteries are stored in a vented battery box;
wherein said base is comprised of a concrete ballast and a rubber mat insulator;
wherein said trailer option comprises a drawbar connected to said base of said portable light tower;
wherein said trailer option allows said portable light tower to be mounted on a vehicle by connecting said drawbar to a connecting rod of said vehicle;
wherein said forklift option comprises one or more rails; and
wherein said one or more rails are configured to engage with a fork of a forklift vehicle for lifting said portable light tower.
